(19) United States
(12) Patent Application Publication
(10) Pub. No.: US 2004/0135573 A1
(43) Pub. Date: Jul. 15, 2004

(54) Magnetic position sensor

(75) Inventors: Dirk Kaltenbach, Wiesbaden (DE); Helmut Stater, Schmitten (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/683,463

(22) Filed: Oct. 14, 2003

(30) Foreign Application Priority Data
Oct. 11, 2002 (EP) 10247590.3

(51) Int. Cl. G01B 7/14; B60Q 1/00; B60R 21/32

(52) U.S. Cl. 324/207.24; 340/457.1; 340/687; 280/735

(57) ABSTRACT

The subject matter of the invention is a magnetic position sensor, in particular for a belt buckle for occupant protection in a motor vehicle, having a magnetic field sensor and a first magnet which can be moved from a first position to a second position, with the first position being arranged away from the magnetic field sensor and the second position being located in the immediate vicinity of the magnetic field sensor.

In order to specify a magnetic position sensor which operates reliably despite an external magnetic interference field, the magnetic field which is produced by the first magnet in its first position has no effective influence on the magnetic field sensor, and a second magnet is formed whose magnetic field differs significantly from that of the first magnet, and the second magnet is arranged in the immediate vicinity of the magnetic field sensor at least when the first magnet is located in its first position, with the second magnet applying a defined magnetic field to the magnetic field sensor, which is superimposed to a sufficient extent on the interference external magnetic fields.

The invention relates to a magnetic position sensor, in particular for a belt buckle for occupant protection in a motor vehicle, having a magnetic field sensor and a first magnet which can be moved from a first position to a second position, with the first position being arranged away from the magnetic field sensor and the second position being located in the immediate vicinity of the magnetic field sensor.

A seatbelt closure which senses a bolt is known from DE 100 58 978 A1. This closure comprises a sensor and a magnet. The magnet can be moved from a first position to a second position when the lockable element is inserted into the aperture of the belt closure. Depending on the position that is assumed, the magnet produces two different magnetic flux densities at the sensor, so that the sensor produces two output signals corresponding to the positions of the magnet.

This apparatus has the disadvantage that, when the magnet is in its position remote from the sensor, only a very small magnetic field strength is applied to the sensor. An external magnetic interference field can easily be superimposed on the magnetic field of the magnet, which results in the sensor emitting a signal which it should produce only when the magnet is located in its immediate vicinity. When a sensor such as this is used in a seatbelt closure for a motor vehicle, this results in the disadvantage that a fault signal such as this can be produced even when the belt buckle is not locked, as a result of which an evaluation circuit incorrectly identifies that the occupant is belted in. A fault source such as this is actually not acceptable in the field of motor vehicle occupant security and protection.

The invention is thus based on the object of specifying a magnetic position sensor, in particular for a belt buckle for occupant protection in a motor vehicle, which operates reliably despite an external magnetic interference field.

According to the invention, the object is achieved in that the magnetic field which is produced by the first magnet in its first position has no effective influence on the magnetic field sensor, and in that a second magnet is formed, whose magnetic field differs significantly from that of the first magnet, and in that the second magnet is arranged in the immediate vicinity of the magnetic field sensor at least when the first magnet is in its first position, with the second magnet applying a defined magnetic field to the magnetic field sensor which is superimposed to a sufficient extent on the interference external magnetic fields.

The invention has the advantage that the second magnet produces a defined magnetic field strength and field direction in the magnetic field sensor, on the basis of which the sensor produces a signal which is associated with the state in which the vehicle occupant is not belted in, with the defined magnetic field strength and field direction of the second magnet being the dominant factor in the sensor, by virtue of its immediate proximity to the sensor, even when an interference external magnetic field is applied in the vicinity of the belt buckle sensor.

In a first refinement of the invention, the first magnet and the second magnet are arranged alongside one another in a plane, with the connecting lines between the north pole and the south pole of the first magnet, and between the north pole and the south pole of the second magnet being largely at right angles to this plane. This makes it possible to arrange the first magnet and the second magnet in a moveable element such that one magnet on the one hand and the other magnet on the other hand is moved into the immediate vicinity of the magnetic field sensor depending on the position of the moveable element. In this case, the magnets may be located directly adjacent to one another, or a specific separation may be provided between the magnets. The moveable element may, for example, be the ejection apparatus of a belt buckle.

In one development, the south pole of the second magnet is arranged on the side of the plane on which the north pole of the first magnet is arranged. Since two different poles face the magnetic field sensor, it is forced to a unique state, which cannot be interfered with by external magnetic influences, in each of the two positions of the moveable element.

In a further refinement, the second magnet is directly opposite the magnetic field sensor when the first magnet is located in its first position. This ensures that the magnetic field sensor is always supplied with a defined magnetic field.

In one embodiment, the second magnet is arranged such that its position cannot be varied on a first field-identifying side of the magnetic field sensor, and is physically connected to the magnetic field sensor. This is a highly cost-effective embodiment since, for example, the second magnet can simply be connected to the magnetic field sensor by adhesive bonding. In this arrangement, the magnetic field which is produced by the first magnet is always applied to the magnetic field sensor.

In a further refinement the first magnet is arranged on a second field-identifying side of the magnetic field sensor, and the first magnet faces the sensor with the same magnetic pole as the second magnet.

In a next development, the first magnet produces a considerably higher field strength than the second magnet.

This means that, when the first magnet is moved into the vicinity of the magnetic field sensor, it can be significantly superimposed on the field strength of the second magnet and thus force the magnetic field sensor to adopt a new switching state.

The invention allows numerous embodiments. Two of these will be explained with reference to the figures that are illustrated in the drawings, in which:

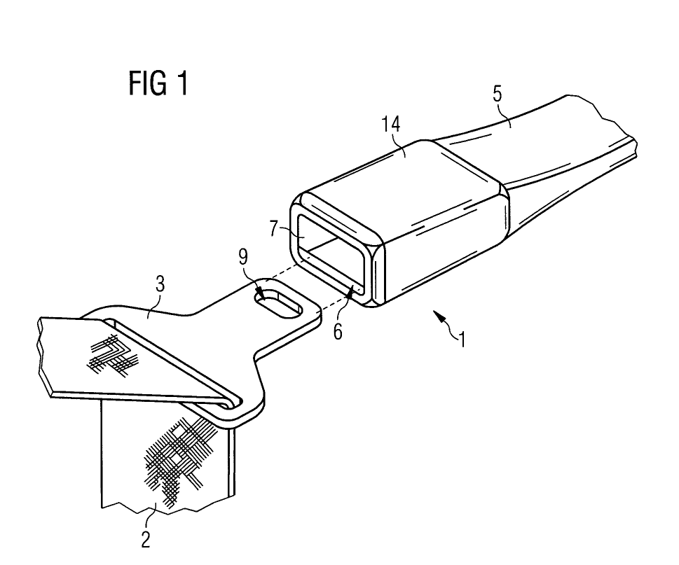

FIG. 1: shows an occupant restraint system which is known from motor vehicles,

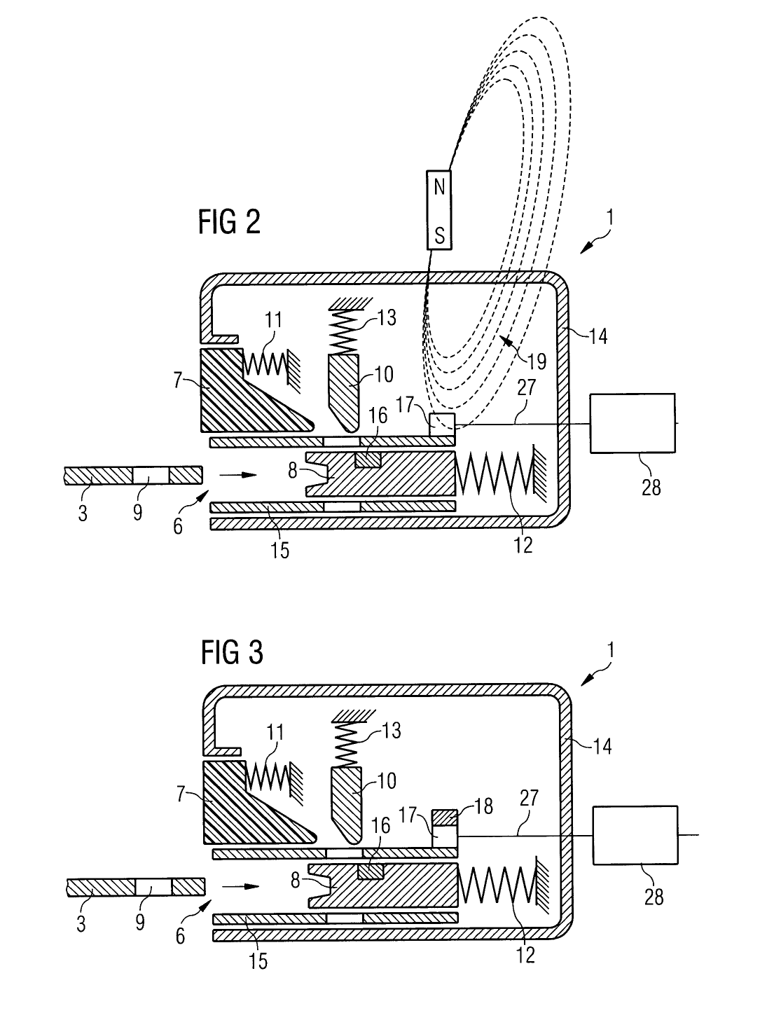

FIG. 2: shows a section through a belt buckle according to the prior art, under the influence of an interference external magnetic field,

FIG. 3: shows a section through a belt buckle with the belt buckle switch according to the invention,

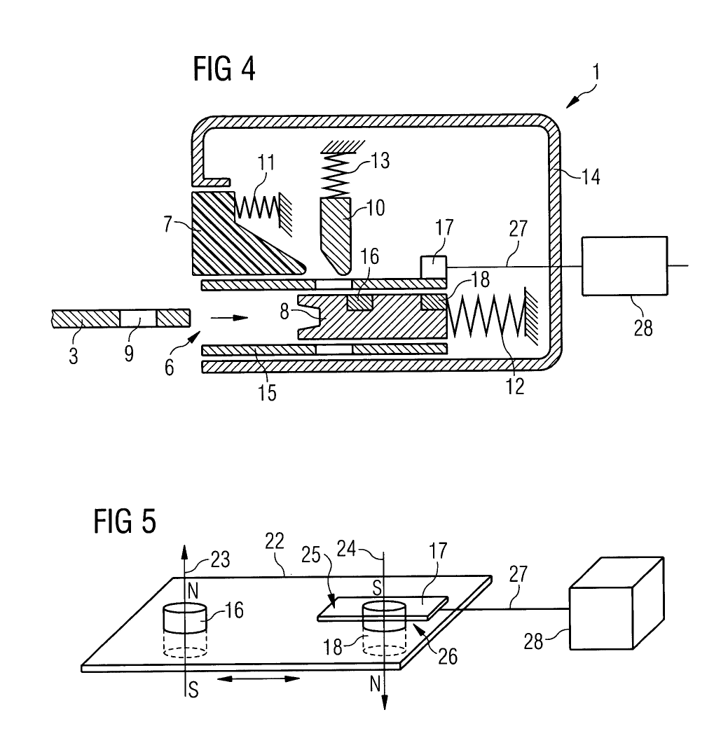

FIG. 4: shows a section through a belt buckle with a further embodiment of the belt buckle switch according to the invention,

FIG. 5: shows the position of the magnets on the plane according to the exemplary embodiment shown in FIG. 4,

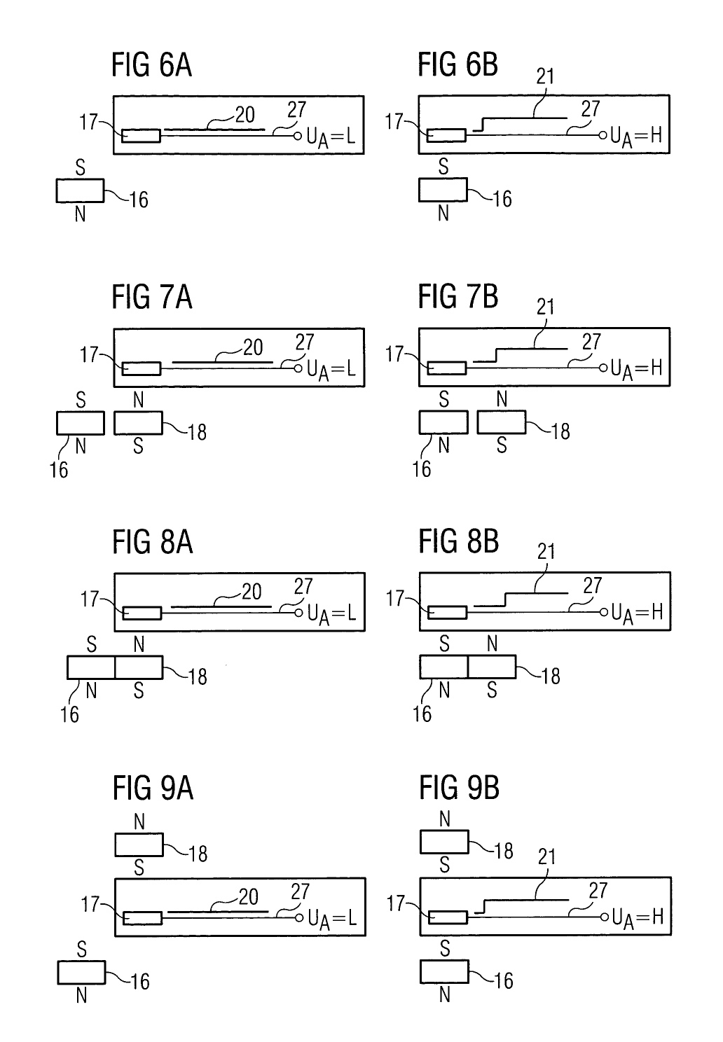

FIGS. 6a and b show schematic illustrations of the belt buckle switch according to the prior art,

FIGS. 7a, 7b, 8a, 8b, 9a an 9b: show schematic illustrations of the belt buckle switch according to the invention.

FIG. 1 shows an occupant restraint system which is known from motor vehicles. The illustration shows a belt buckle 1 with a housing 14, a push button 7 and an opening 6 into which the belt bolt 3 can be inserted. The belt buckle 1 is firmly connected to a solid anchor cable 5, which is in turn anchored on the vehicle, which is not illustrated. For occupant protection, the belt bolt 3 is pushed into the belt buckle 1, with a locking bolt which is not illustrated here snapping into the elongated hole 9 and firmly locking the belt bolt 3. The seatbelt 2 which is passed through the belt bolt 3 holds the occupant of a vehicle firmly in his or her seat in the event of an impact. The belt bolt 3 can be released from the belt buckle 1 by operating the push button 7. The belt buckle 1 illustrated in FIG. 1 is illustrated in more detail in FIG. 2.

FIG. 2 shows a section through a belt buckle according to the prior art. The illustration in FIG. 2 essentially has the following features. A belt bolt 3 with an elongated hole 9 and the belt buckle 1 with a locking bolt 10 which is pushed through a spiral spring 13 to the desired position. An ejection apparatus 8, which is likewise held in the appropriate position by a spiral spring 12, as well as a push button 7 which is held in the predetermined position by the spiral spring 11. The belt bolt 3 is shown in front of the opening 6 in the belt buckle 1. The belt bolt 3 is thus not locked in the belt buckle 1, and the vehicle occupant would not be belted in. The locking bolt 10 is located in an upper position, and is pressed by the spiral spring 13 against the ejection apparatus 8.

A first permanent magnet 16 is incorporated in the ejection apparatus 8. Since the belt bolt 3, which is not inserted, has not pushed the ejection apparatus 8 back against the force of the spiral spring 12, the permanent magnet 16 is well away from the magnetic field sensor 17. The magnetic field sensor 17 does not identify the magnetic field of the first permanent magnet 16, since the field strength of the first permanent magnet 16 is not sufficient when it is at this distance from the magnetic field sensor 17 to influence it effectively.

When the vehicle occupant is belted in, the belt bolt 3 is pushed into the opening 6 in the belt buckle 1. In consequence, the ejection apparatus 8 is pushed back against the spring force of the spiral spring 12, and the locking bolt 10 can be snapped into the elongated hole 9 in the belt bolt 3. A force which acts on the belt bolt 3 via the seatbelt 2 is transmitted directly to the locking bolt 10 at the elongated hole 9 in the belt bolt 3. The locking bolt 10 is, however, directly connected to the anchor plate 15, which is in turn connected firmly to the motor vehicle via the anchor cable 5. This results in a force-transmitting connection from the seatbelt 2 to the vehicle bodywork, which is not illustrated here.

When the belt bolt 3 is inserted into the opening 6 in the belt buckle 1, the belt bolt 3 pushes the ejection apparatus 8 back against the spring force of the spiral spring 12. In consequence, the first permanent magnet 16 is moved into the immediate vicinity of the magnetic field sensor 17. The magnetic field of the first permanent magnet 16 now acts on the magnetic field sensor 17 from a short distance. The magnetic field sensor 17 thus generates a different switching state to that when the belt bolt was not inserted. The magnetic field sensor 17 now identifies that the vehicle occupant has been belted in. The signals which are produced by the magnetic field sensor 17 are supplied via an electrical line 27 to an evaluation circuit 28 for further processing.

The disadvantage of the solution according to the prior art is clear when an external magnetic interference field 19 is applied to the bolt buckle 1 when the belt bolt 3 is not inserted. Since the magnetic field sensor 17 is not influenced, or is influenced only to a very minor extent, by the magnetic field of the first permanent magnet 16, it should generate the “vehicle occupant not belted in” signal.

However, if there is an external magnetic interference field 19 in the vicinity of the belt buckle when the belt bolt 3 is not inserted, then the magnetic field sensor 17 can generate a signal which it should generate only when the vehicle occupant is belted in. This incorrectly generated signal may cause a considerable safety risk for a vehicle occupant since, on the one hand, no warning is emitted that the vehicle occupant is not belted in and, on the other hand, further safety systems such as an airbag or belt tightening controller are supplied with incorrect information and would react as if the vehicle occupant were belted in. Interference magnetic fields in a motor vehicle can originate from various sources. On the one hand, it is conceivable for the vehicle occupant, for example, to have a permanent magnet as a key ring fob which is located in the vicinity of the belt buckle while, on the other hand, there are many sources for magnetic fields in the motor vehicle itself, for example a magnetic valve control. Based on the problem illustrated in FIG. 2, a belt buckle sensor according to the invention is illustrated in FIG. 3.

FIG. 3 includes the features that are known from FIG. 2 plus a second permanent magnet 18. The magnetic position sensor according to the invention is composed of a first permanent magnet 16, a magnetic field sensor 17 and a second permanent magnet 18. The field strength which is produced by the first permanent magnet 16 is considerably greater than the field strength which is produced by the second permanent magnet 18. In this exemplary embodiment, the second permanent magnet 18 is arranged in a fixed position directly on the magnetic field sensor 17 and produces a magnetic field strength in it which can be influenced only insignificantly by an interference external magnetic field. When the magnetic field sensor 17 detects the field strength which is caused by the second permanent magnet 18, then the magnetic field sensor 17 identifies that the vehicle occupant is not belted in. The signal which is produced by the magnetic field sensor 17 is supplied to the evaluation circuit 28 via the electrical line 27.

However, when the belt bolt 3 is inserted into the opening 6, with the ejection apparatus 8 being pushed back, then the first permanent magnet 16 is located in the immediate vicinity of the magnetic field sensor 17. Since the field strength of the first permanent magnet 16 is considerably greater than the field strength of the second permanent magnet 18, the magnetic field sensor 17 now identifies the first permanent magnet 16. Due to the immediate proximity of the first permanent magnet 16, the magnetic field sensor 17 now generates a signal which represents the state in which the vehicle occupant is belted in. The evaluation circuit 28 supplies downstream appliances, such as the airbag controller, with the appropriate information. Interference caused by external magnetic fields is prevented by the magnetic position sensor according to the invention, because the magnetic field sensor 17 has a defined magnetic field applied to it not only when the occupant is belted in but also when the occupant is not belted in.

FIG. 4 shows a further possible embodiment of the position sensor according to the invention. The features illustrated in FIG. 4 correspond largely to the features illustrated in FIG. 2. In the embodiment of the position sensor according to the invention illustrated here, both the first permanent magnet 16 and the second permanent magnet 18 are incorporated in the ejection apparatus 8. FIG. 4 shows the state in which the vehicle occupant is not belted in. The belt bolt 3 is located outside the belt buckle 1. The spiral spring 12 presses the ejection apparatus 8 in the direction of the opening 6. In this position, the magnetic field sensor 17 is in direct contact with the second permanent magnet 18.

When the belt bolt 3 is now inserted into the opening 6, then the belt bolt 3 presses the ejection apparatus 8 back against the spring force of the spiral spring 12 until the locking bolt 10 latches into the elongated hole 9. On reaching this position, the first permanent magnet 16 is now in direct contact with the magnetic field sensor 17. The second permanent magnet 18 no longer has any influence on the magnetic field sensor 17. The polarity of the first permanent magnet 17 is chosen to be precisely the opposite of the polarity of the second permanent magnet 18. In consequence, when it is in direct contact with the first permanent magnet 16, the magnetic field sensor 17 produces a different signal to that produced when it is in direct contact with the second permanent magnet 18. When the second permanent magnet 18 is directly opposite the magnetic field sensor 17, the “occupant not belted in” signal is generated. When the first permanent magnet 16 is in direct contact with the magnetic field sensor 17, then the “occupant belted in” signal is generated. Since the magnetic field sensor 17 according to the invention is always in contact with one permanent magnet or the other, an interference magnetic field which is applied from the outside does not lead to incorrect identification of the occupant belted-in state. The permanent magnets which are introduced here may, of course, be replaced individually or in their totality by other elements that produce magnetic fields, for example electromagnets.

FIG. 5 indicates the position of the magnets 16, 18, as illustrated in FIG. 4, and of the magnetic field sensor 17 with respect to one another. The ejection apparatus 8, which is known from FIG. 4, defines a plane 22 in which the first magnet 16 and the second magnet 18 are arranged. The connecting lines between the north pole N and the south pole S of the first magnet 16 and of the second magnet 18 pass through the plane 22 virtually at right angles. The plane 22 can be moved linearly along the connecting line between the magnets, as is indicated by the arrow. The magnetic field sensor 17 is arranged above this plane 22, and a second field-identifying side 26 of it faces the magnets 16, 18. The first field-identifying side 25 of the magnetic field sensor is used when an exemplary embodiment as shown in FIG. 3 is implemented.

According to the exemplary embodiment shown in FIG. 4, the north pole N of the first permanent magnet 26 faces the magnetic field sensor 17, as is shown in FIG. 5, and the south pole (S) of the second permanent magnet 18 faces the magnetic field sensor 17. Depending on the position of the plane 22, the magnetic field sensor 17 is influenced on the one hand by the north pole N of the first permanent magnet 16, or by the south pole S of the second permanent magnet 18.

FIGS. 6a and 6b once again illustrate the belt buckle switch according to the prior art schematically. The major features are the first permanent magnet 16 and the magnetic field sensor 17. FIG. 7a shows the position of the first permanent magnet 16 with respect to the magnetic field sensor 17 when the vehicle occupant is not belted in. The first permanent magnet 16 is positioned at a sufficient distance from the magnetic field sensor 17 but the field strength from the first permanent magnet 16 is not sufficient to force the magnetic field sensor 17 to carry out a switching process. The magnetic field sensor 17 thus produces the “occupant not belted in” signal 20 (U_{A}=L).

If, as is illustrated in FIG. 6b, the first permanent magnet 16 is now moved into the immediate vicinity of the magnetic field sensor 17, then the magnetic field of the first permanent magnet 16 is detected by the magnetic field sensor 17 with a high field strength, forcing it to carry out a switching process. The magnetic field sensor 17 then generates the “occupant belted in” signal 21 (U_{A}=H).

FIGS. 7 to 9 show various embodiments of the belt buckle switch according to the invention, illustrated schematically. In addition to the first permanent magnet 16 and the magnetic field sensor 17, there is always a second permanent magnet 18 in this case.

In FIG. 7a, the first permanent magnet 16 and the second permanent magnet 18 are arranged alongside one another in a plane parallel to one field-identifying surface of the magnetic field sensor 17. The second permanent magnet 18 is positioned in the immediate vicinity of the magnetic field sensor 17. The magnetic field sensor 17 detects the field strength of the second permanent magnet 18 and produces the “occupant not belted in” signal 20 (U_{A}=L). A further interference magnetic field, which is applied from the outside, cannot force the magnetic field sensor 17 to an incorrect switching state, since the field strength of the external magnetic field will in general not exceed the field strength of the second permanent magnet 18 at the location of the magnetic field sensor 17.

FIG. 7b shows the position of the first permanent magnet 16 and of the second permanent magnet 18 with respect to the magnetic field sensor 17 when the occupant is belted in. The second permanent magnet 18 is now no longer located in the immediate vicinity of the magnetic field sensor 17. For this purpose, the first permanent magnet 16 is moved into the immediate vicinity of the magnetic field sensor 17. The field strength of the first permanent magnet 16 is sufficient to switch the magnetic field sensor 17 to the “occupant belted in” state.

In order to clearly predetermine the two switching states for the magnetic field sensor 17, the permanent magnets 16 and 18 have opposite polarity. The first permanent magnet 16 in this example has its south pole on the side facing the magnetic field sensor 17, while the second magnetic field sensor 18 has its north pole on the side facing the magnetic field sensor 17. This opposite polarization of the two magnets 16 and 18 ensures correct identification of the two switching states “occupant not belted in” and “occupant belted in”. The field strength of external interference magnetic fields is generally not sufficient to be superimposed on the field strengths of the two permanent magnets 16 and 18 and to force the magnetic field sensor 17 to produce incorrect signals.

FIGS. 8a and 8b show how the first permanent magnet 16 and the second permanent magnet 18 may always advantageously be directly adjacent to one another, in order to represent the belt buckle switch according to the invention. The only important factor in this case is the opposite polarization of the first permanent magnet 16 and of the second permanent magnet 18 with reference to the field-identifying side of the magnetic field sensor 17, and their position with respect to the magnetic field sensor 17 when the occupant is not belted in, as is illustrated in FIG. 8a, and when the occupant is belted in, as illustrated in FIG. 8b. FIGS. 9a and 9b schematically illustrate a further embodiment of the position switch according to the invention. In this case, the second permanent magnet 18 is always arranged in the immediate vicinity of the magnetic field sensor 17. The second permanent magnet 18 does not move. In contrast, the first permanent magnet 16 in FIG. 9a is arranged such that it moves at a sufficient distance from the magnetic field sensor 17. The field strength which is produced by the second permanent magnet 18 is sufficiently large to switch the magnetic field sensor 17 to the “occupant not belted in” state for as long as the first permanent magnet 16 is not positioned in the immediate vicinity of the magnetic field sensor 17. This is shown in FIG. 9a. External interference magnetic fields cannot be superimposed on the magnetic field strength of the second permanent magnet 18 in a manner which causes interference to the magnetic field sensor 17.

FIG. 9b shows the position of the first permanent magnet 16 when the vehicle occupant is belted in. The first permanent magnet 16 has a considerably greater field strength than the second permanent magnet 18. When the first permanent magnet 16 is located in the immediate vicinity of the magnetic field sensor 17, then it is significantly superimposed on the magnetic field strength which is produced by the second permanent magnet 18. When the first permanent magnet 16 is in this position, the magnetic field sensor 17 will produce the “occupant belted in” switching state. Since the first permanent magnet 16 is arranged under the magnetic field sensor 17 and the second permanent magnet 18 is arranged above the magnetic field sensor 17, it is important for the same pole of each of the two permanent magnets 16 and 18 to face the magnetic field sensor 17. In this example, the south poles of both permanent magnets 16 and 18 face the magnetic field sensor 17.

However, since the field strength of the first permanent magnet 16 is significantly greater than that of the second permanent magnet 18, the first permanent magnet 16, which is arranged under the magnetic field sensor 17, can switch the magnetic field sensor 17 to the “occupant belted in” switching state.

When the first permanent magnet 16 is at a distance from the magnetic field sensor 17 as illustrated in FIG. 9a, then the south pole of the second permanent magnet 18 dominates the magnetic field sensor 17, and the “occupant not belted in” switching state is reached.

1. A magnetic position sensor, in particular for a belt buckle (1) for occupant protection in a motor vehicle, having a magnetic field sensor (17) and a first magnet (16) which can be moved from a first position to a second position, with the first position being arranged away from the magnetic field sensor (17) and the second position being located in the immediate vicinity of the magnetic field sensor (17),
characterized in that the magnetic field which is produced by the first magnet (16) in its first position has no effective influence on the magnetic field sensor (17), and in that a second magnet (18) is formed, whose magnetic field differs significantly from that of the first magnet (16), and in that the second magnet (18) is arranged in the immediate vicinity of the magnetic field sensor (17) at least when the first magnet (16) is in its first position, with the second magnet (18) applying a defined magnetic field to the magnetic field sensor (17) which is superimposed to a sufficient extent on the interference external magnetic fields (19).

2. The magnetic position sensor as claimed in claim 1,
characterized in that the first magnet (16) and the second magnet (18) are arranged alongside one another in a plane (22), with the connecting lines (23; 24) between the north pole (N) and the south pole (S) of the first magnet (16), and between the north pole (N) and the south pole (S) of the second magnet (18) being largely at right angles to this plane (22).

3. The magnetic position sensor as claimed in claim 2,
characterized in that the south pole (S) of the second magnet (18) is arranged on the side of the plane (22) on which the north pole (N) of the first magnet (16) is arranged.

4. The magnetic position sensor as claimed in claim 3,
characterized in that the second magnet (18) is directly opposite the magnetic field sensor (17) when the first magnet (16) is located in its first position.

5. The magnetic position sensor as claimed in claim 1,
characterized in that the second magnet (18) is arranged such that its position cannot be varied on a first field-identifying side (25) of the magnetic field sensor (17).

6. The magnetic position sensor as claimed in claim 5,
characterized in that the second magnet (18) is physically connected to the magnetic field sensor (17).

7. The magnetic position sensor as claimed in claim 6,
characterized in that the first magnet (16) is arranged on a second field-identifying side (26) of the magnetic field sensor (17), and in that the first magnet (16) faces the sensor with the same magnetic pole as the second magnet (18).

8. The magnetic position sensor as claimed in claim 7,
characterized in that the first magnet (16) produces a considerably greater field strength than the second magnet (18).
